(19) United States
(12) Patent Application Publication
(10) Pub. No.: US 2019/0197032 A1
(43) Pub. Date: Jun. 27, 2019

(54) PREVENTING UNNECESSARY MODIFICATIONS, WORK, AND CONFLICTS WITHIN A DISPERSED STORAGE NETWORK

(71) Applicant: International Business Machines Corporation, Armonk, NY (US)

(72) Inventors: Adam M. Gray, Chicago, IL (US); Greg R. Dhuse, Chicago, IL (US)

(21) Appl. No.: 16/291,189

(22) Filed: Mar. 4, 2019

Related U.S. Application Data
(63) Continuation-in-part of application No. 15/006,845, filed on Jan. 26, 2016, now Pat. No. 10,282,440.
(60) Provisional application No. 62/141,034, filed on Mar. 31, 2015.

(51) Int. Cl. G06F 16/23; H04L 29/12

(52) U.S. Cl. CPC G06F 16/2365; H04L 61/1511; G06F 16/2315

(57) ABSTRACT

A method begins by receiving, from a requesting device of the DSN, a write request to edit existing data stored in the DSN with new data, where the write request includes the new data and information regarding the new data. The method continues by determining, based on existing data information and the new data information, whether the existing data has already been edited with the new data. When the existing data has already been edited, the method continues with sending, without executing the write request, a favorable response to the requesting unit indicating the existing data has been successfully edited. When the existing data has not already been edited, the method continues with executing the write request to edit the existing data with the new data to produce edited data. After successful execution of the first write request, the method continues by sending the favorable response to the requesting device.

### CROSS-REFERENCE TO RELATED APPLICATIONS

The present U.S. Utility Patent Application claims priority pursuant to 35 U.S.C. § 120 as a continuation-in-part of U.S. Utility application Ser. No. 15/006,845, entitled “PRIORITIZING REBUILDING OF ENCODED DATA SLICES”, filed Jan. 26, 2016, which claims priority pursuant to 35 U.S.C. § 119(e) to U.S. Provisional Application No. 62/141,034, entitled “REBUILDING ENCODED DATA SLICES ASSOCIATED WITH STORAGE ERRORS,” filed Mar. 31, 2015, expired, both of which are hereby incorporated herein by reference in their entirety and made part of the present U.S. Utility Patent Application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to computer networks and more particularly to dispersed storage error encoded data.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9 is a schematic block diagram of another embodiment of a dispersed storage network (DSN) in accordance with the present invention;

FIG. 10 is a flowchart illustrating an example of processing storage of redundant data in accordance with the present invention;

FIG. 11 is schematic block diagram of receiving a write request with new data in accordance with the present invention; and

FIG. 12 is a flowchart illustrating an example of editing existing data in a dispersed storage network in accordance with the present invention.

### DETAILED DESCRIPTION OF THE INVENTION

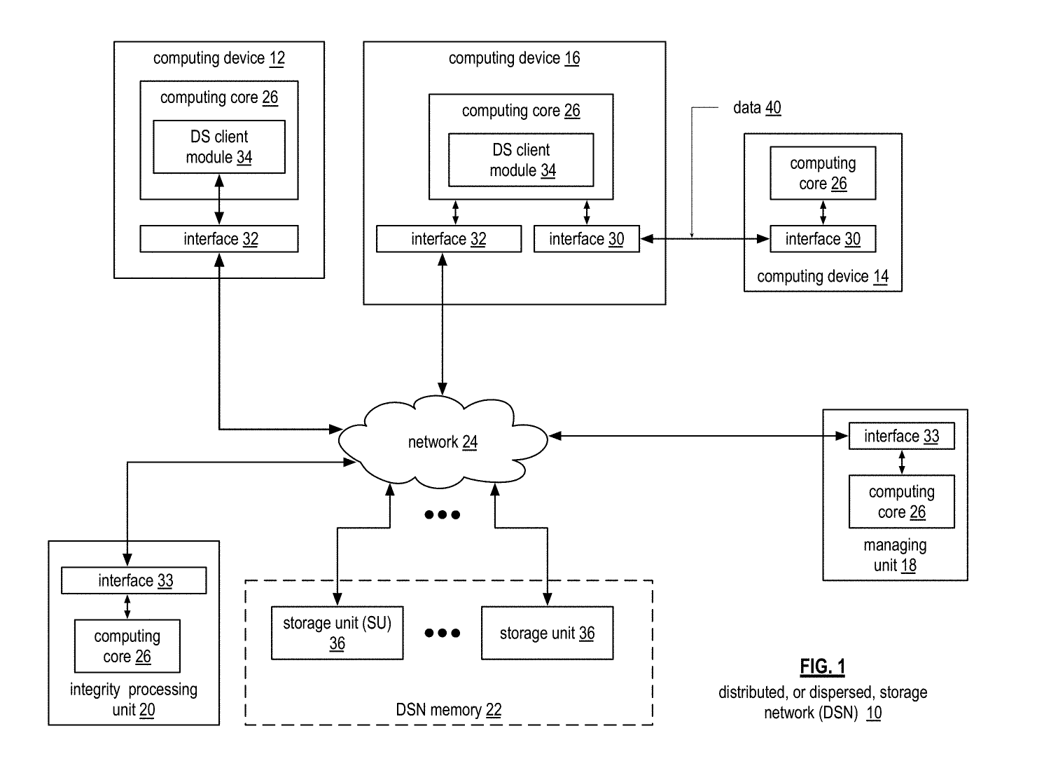

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

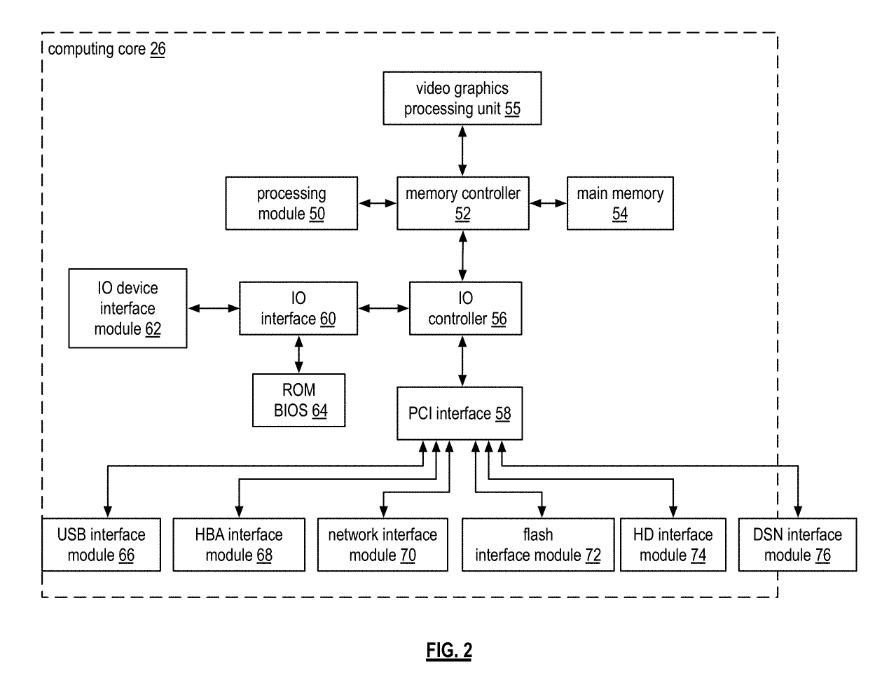

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 & 16 and the DSN memory 22. As yet another example, interface 33 supports a communication link for each of the managing unit 18 and the integrity processing unit 20 to the network 24.

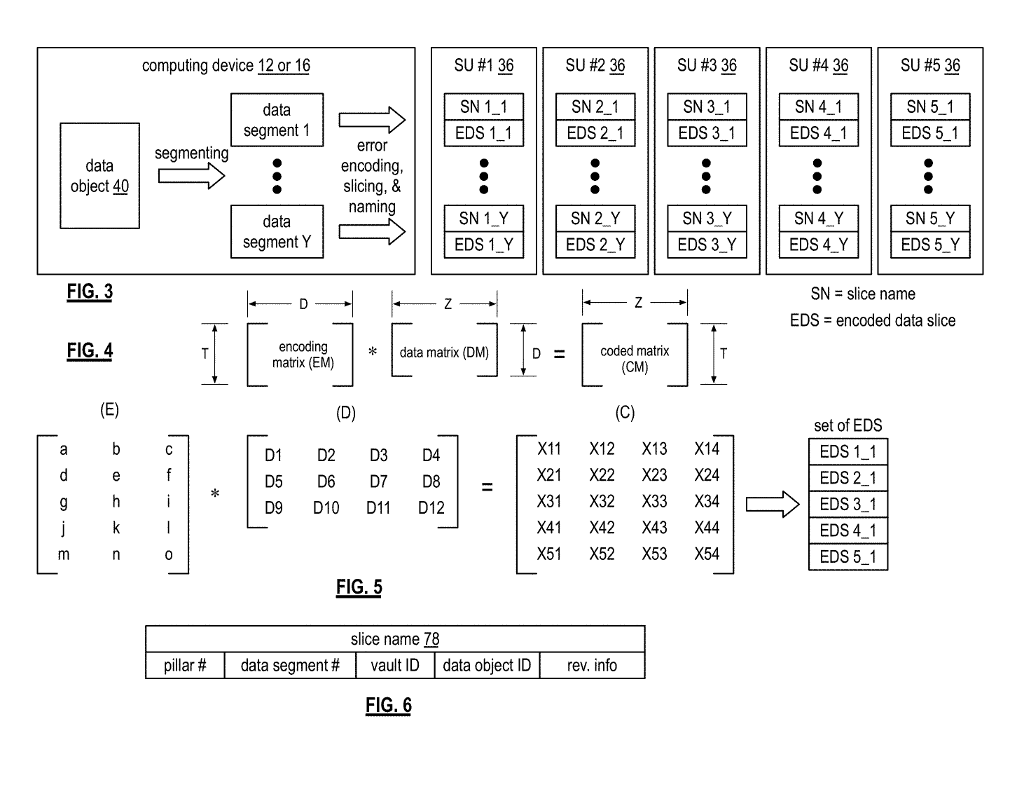

Computing devices 12 and 16 include a dispersed storage (DS) client module 34, which enables the computing device to dispersed storage error encode and decode data as subsequently described with reference to one or more of FIGS. 3-8. In this example embodiment, computing device 16 functions as a dispersed storage processing agent for computing device 14. In this role, computing device 16 dispersed storage error encodes and decodes data (e.g., data 40) on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The DSN managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The DSN managing unit 18 creates billing information for a particular user, a user group, a vault access, public vault access, etc. For instance, the DSN managing unit 18 tracks the number of times a user accesses a non-public vault and/or public vaults, which can be used to generate a per-access billing information. In another instance, the DSN managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

Returning to the discussion of FIG. 3, the computing device also creates a slice name (SN) for each encoded data slice (EDS) in the set of encoded data slices. A typical format for a slice name 78 is shown in FIG. 6. As shown, the slice name (SN) 78 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

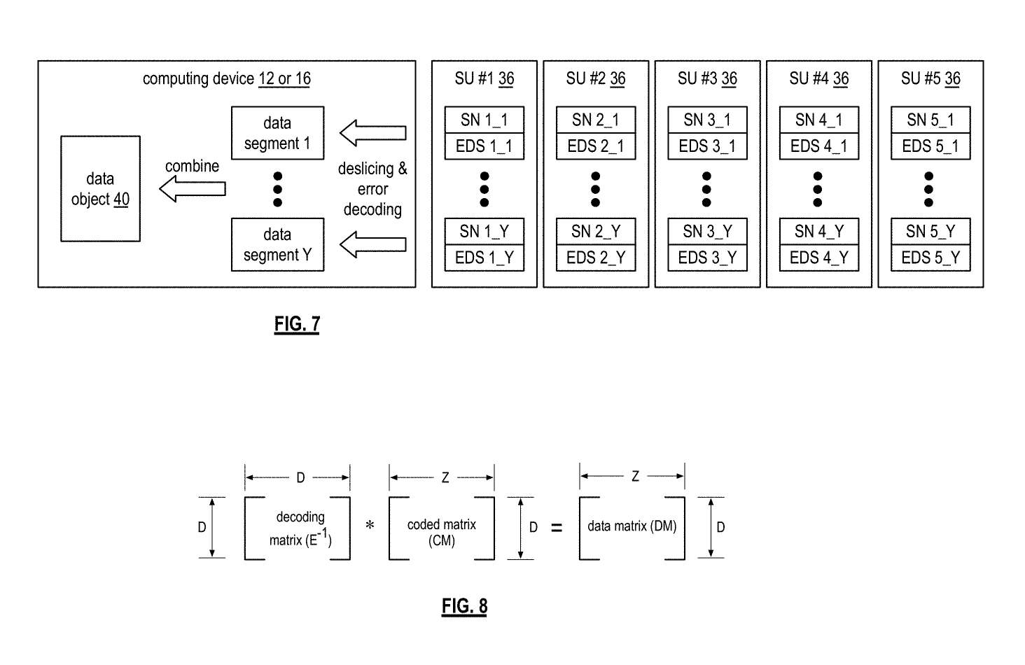

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

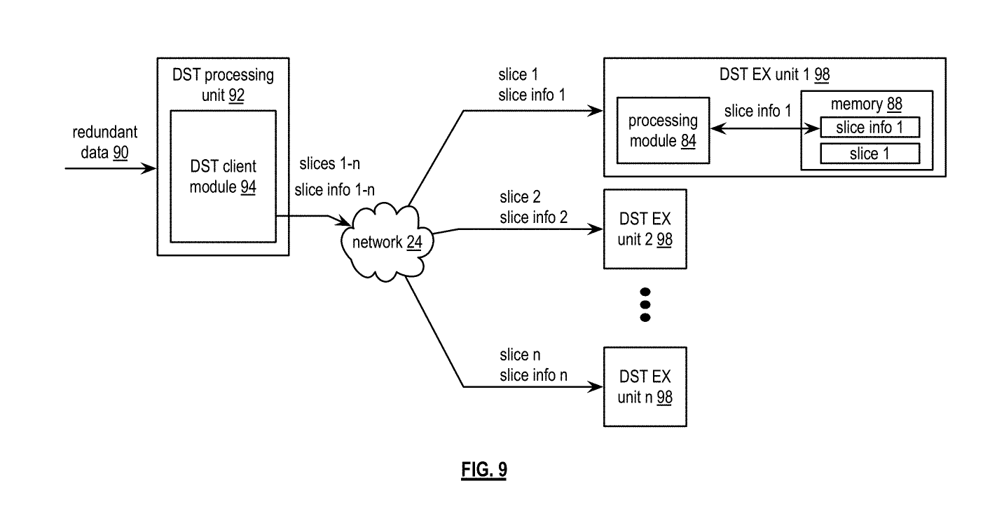

FIG. 9 is a schematic block diagram of another embodiment of a dispersed storage network (DSN) that includes a distributed storage and task (DST) processing unit 92, the network 24 of FIG. 1, and a set of DST execution (EX) units 98 1-n. The DST processing unit 92 includes a DST client module 34. Each DST execution unit includes a processing module 84 and a memory 88. Each DST execution unit 98 may be implemented utilizing a storage unit 36 of FIG. 1. The DST client module 94 may be implemented by the DS client module 34 of FIG. 1. The DST processing unit 92 may be implemented utilizing one of the computing devices 12-16, the managing unit 18 and the integrity processing unit 20 of FIG. 1. The DSN functions to process storage of redundant data 90 within the set of DST execution units 98.

In an example of operation of the storing of the redundant data 90, the DST client module 94 receives the redundant data 90 for storage. Having received the redundant data 90 for storage, the DST client module 94 dispersed storage error encodes the redundant data 90 to produce a plurality of sets of encoded data slices 1-n. Having produced the plurality of sets of encoded data slices, the DST client module 94 produces slice information 1-n, where the slice information corresponds to the plurality of sets of encoded data slices. In particular, the slice information includes one or more of a source name, a data name of the redundant data, a slice name, a revision number, a data size indicator, a slice size indicator, integrity information for the redundant data, and a slice integrity information (e.g., a result of performing a one-way deterministic function on an encoded data slice).

Having produced the plurality of sets of encoded data slices and the slice information, the DST client module 94 sends, via the network 24, write slice requests that includes the slices and the slice information to the set of DST execution units 98. At least some of the DST execution units 98 receives a corresponding write slice request. Having received the corresponding write slice request, the processing module 84 of each DST execution unit obtains a first level characterization with regards to an encoded data slice of the write slice request. The first level characterization includes at least one of a slice size, a slice revision number, and a slice name. The obtaining includes at least one of extracting from the received slice information of the write slice request and interpreting the received encoded data slice. For example, the processing module 84 of the DST execution unit 1 obtains the slice size from the slice information 1.

Having obtained the first level characterization, the DST execution unit 98 compares the obtained first level characterization with a stored first level characterization from corresponding slice information retrieved from the memory 88. For example, the processing module 84 of the DST execution unit 1 compares the slice size from the received slice information 1 to a corresponding retrieved slice size from retrieved slice information 1 from the memory 88 of the DST execution unit 1. When the first level slice characterization substantially matches a portion of stored slice information for a corresponding stored encoded data slice, the DST execution unit obtains a second-level slice characterization. The second level characterization includes slice integrity information. The obtaining includes at least one of performing a slice integrity function on the received encoded data slice to produce a calculated slice integrity information and extracting received slice integrity information from the received slice information. For example, the processing module 84 of the DST execution unit 1 performs the slice integrity function on a received encoded data slice 1 to produce calculated slice integrity information 1.

Having obtained the second-level slice characterization, the DST execution unit compares the obtained second-level slice characterization with a portion of stored slice information corresponding to the encoded data slice. For example, the processing module 84 compares the calculated slice integrity information 1 to stored slice integrity information 1 retrieved from the memory 88 of the DST execution unit 1.

When the second-level characterization substantially matches another portion of the stored slice information for the corresponding stored encoded data slice, the DST execution unit updates the stored slice information based on the received slice information. For example, the processing module 84 of the DST execution unit 1 updates a revision number of the stored slice information 1 to produce updated slice information 1 based on a received revision number of the received slice information 1 and stores the updated slice information 1 in the memory 88 of the DST execution unit 1.

Alternatively, or in addition to, when either the first or second-level characterizations cannot match the corresponding portions of the stored slice information, the processing module 84 facilitates storage of the received encoded data slice in the memory 88 of the DST execution unit and updates the stored slice information based on the received slice information (e.g., stores the associated slice name and revision number).

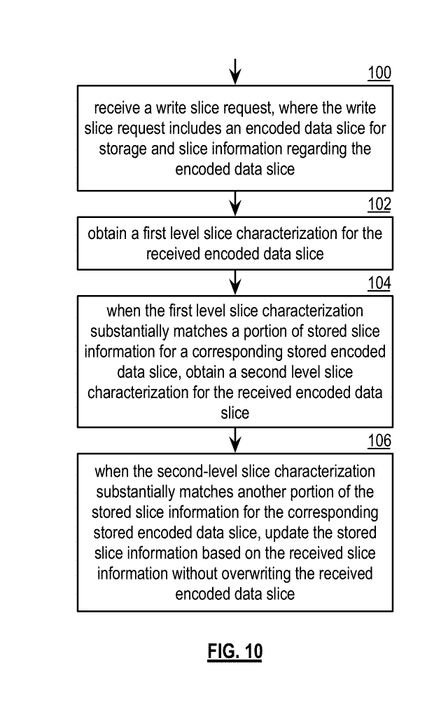

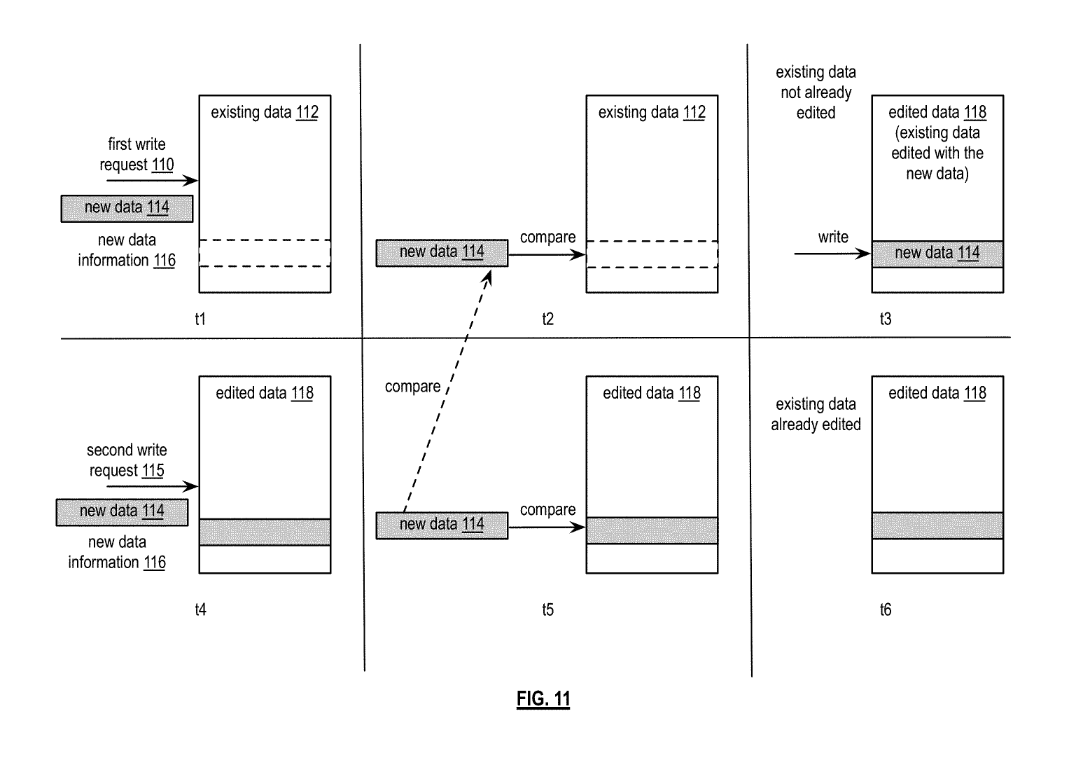

FIG. 10 is a flowchart illustrating an example of processing storage of redundant data. The method includes step 100, where a processing module (e.g., of a distributed storage and task (DST) execution unit 98) receives a write slice request. In one example, the write slice request includes an encoded data slice for storage and slice information regarding the encoded data slice. The method continues at step 102, where the processing module obtains a first level slice characterization for the received encoded data slice. The obtaining includes at least one of extracting the first level slice characterization from the received slice information and interpreting the received encoded data slice to produce the first level slice characterization.

When the first level slice characterization substantially matches a portion of stored slice information for a corresponding stored encoded data slice, the method continues at step 104 where the processing module obtains a second-level slice characterization for the received encoded data slice. For example, the processing module matches a received slice size with a stored slice size for a stored encoded data slice of a slice name of the received write slice request. As an example of the obtaining, the processing module performs a slice integrity function on the received encoded data slice to produce calculated slice integrity information. As another example of the obtaining, the processing module extracts slice integrity information from the received slice information.

When the second-level slice characterization substantially matches another portion of the stored slice information for the corresponding stored encoded data slice, the method continues at step 106 where the processing module updates the stored slice information based on the received slice information without overwriting the received encoded data slice. For example, the processing module matches the calculated slice integrity information with stored slice integrity information for the corresponding stored encoded data slice. As an example of the updating, the processing module updates a received revision level of the received slice information to produce the updated stored slice information for storage. Alternatively, or in addition to, when either the first or second-level slice characterizations cannot match the corresponding portions of the stored slice information, the processing module facilitates storage of the received encoded data slice in a memory of the storage unit and updates the stored slice information based on the received slice information.

FIG. 11 is schematic block diagram of receiving a write request to overwrite existing data with new data. In one example of operation, at time (t1) a computing device receives a first write request 110 to overwrite existing data 112 with new data 114. The first write request 110 includes information 116 regarding the new data and the new data 114. For example, the information 116 includes one or more of a user tag of the new data, a size of the new data, a data type of the new data, a revision number of the new data, a name of the new data, and integrity information of the new data.

In a first example, the new data is to edit (e.g., overwrite, delete, etc.) all of the existing data. For instance, the existing data is a data segment of a first size and the new data is a data segment of the first size. In a second example, the new data is to edit a portion of the data. For instance, the existing data is group of encoded data slices and the new data is an encoded data slice of the group of encoded data slices. As another instance, the existing data is a data object and the new data is a data segment of the data object.

Having received the first write request, at time t2, the computing device compares the new data with at least a portion (e.g., an encoded data slice of a group of encoded data slices, a set of encoded data slices of a plurality of sets of encoded data slices, a data segment of a data object, a data object of a plurality of data objects, etc.) of the existing data. As an example, the comparing includes determining whether information regarding the new data substantially matches information regarding the existing data. The information of the existing data and/or the new data includes one or more of a data size, a revision level, a data type, a user tag, a data name, the new data, the existing data, and integrity information.

As a specific example, the comparing includes determining whether the size of the new data is substantially equal to the size of the existing data (e.g., the corresponding portion of the existing data that is to be overwritten with the new data). As another specific example, the comparing includes determining whether a data type (e.g., audio file, movie file, etc.) of the new data substantially matches the data type of the existing data. As yet a further specific example, when the computing device is the DS processing unit, a data name (e.g., source name) of the new data is compared to a data name of the existing data. As yet still a further specific example, when the computing device is the storage unit, a data name (e.g., slice name) of the new data is compared to a data name of the existing data. In another specific example, the comparing includes determining whether integrity information (e.g., hash function (e.g., SHA-3 MD5, etc.), checksum (e.g., CRC32, Adler-32, etc.), fingerprint, etc.) of the new data substantially matches integrity information of the at least a portion of the existing data.

In an embodiment, the comparing includes an order of execution of which information to compare to determine whether the existing data has been edited. As a specific example, the order includes first; comparing one or more of a size, a data type and a user tag, second; comparing one or more of a data name and a revision level, and third; comparing one or more of a fingerprint and a hash. Note the order may include more or less groups. For example, the order includes a group for each piece of information regarding the new data and the existing data. Further, in another example, the information in each group is ordered. For example, the computing device for the first group of information first compares a size of the new data with a size of the existing data, second compares a data type of new data with a data type of the existing data, and third compares a user tag of the new data with a data tag of the existing data.

Continuing with the example, at time t3, the computing device determines (based on one or more of the comparisons) that the existing data has not already been edited. The computing device then edits the existing data with the new data (e.g., writes the new data to storage, sends the new data to memory of the DSN for storage, etc.) to produce edited data 118.

At time t4, the computing device receives a second write request 115 that includes new data 114 and new data information 116. Note that time t4 may be any time after t1 (e.g., not necessarily after t2 and t3). At time t5, the computing device compares the new data with the existing data (e.g., now as edited data 118). Having already edited the existing data with the new data, the computing device determines the existing data has already been edited. For example, the computing device compares a size of the new data with a size of the edited data the new data is to overwrite. When the size of the new data substantially matches the size of the edited data, the computing device determines to obtain integrity information for the new data and the existing data. The computing device determines the integrity information regarding the new data substantially matches the integrity information regarding the existing data. Thus, the computing device does not edit the existing data (e.g., perform the write request) and sends a favorable response (e.g., indicating the new data is stored in DSN memory) to the requesting device.

Alternatively, or in addition to, the computing device receives a second write request 115 (e.g., from another requesting device) and determines that a first write request 110 regarding the new data has also been received and flagged for comparison with the existing data. Instead of comparing (alternatively, instead of only comparing) the second new data (e.g., of the second write request) to the existing data, the computing device compares the second new data with the first new data (e.g., of the first write request). For example, the computing device obtains and compares first new data information with second new data information, and when a threshold number of the first new data information substantially matches the second new data information, the computing device determines obtains results from the comparison of the first new data (e.g., of the first write request) with the existing data.

The computing device then determines to respond to the second write request based on the determining whether the existing data has already been edited (e.g., the comparing the new data of the first write request with the existing data). For example, the computing device determines for the first write request that the existing data has already been edited. Thus, the computing device sends, without editing the existing data, a first write response to the requesting device indicating successful storage of the new data. The computing device also sends, without editing the existing data, a second write response to the other requesting device indicating successful storage of the new data.

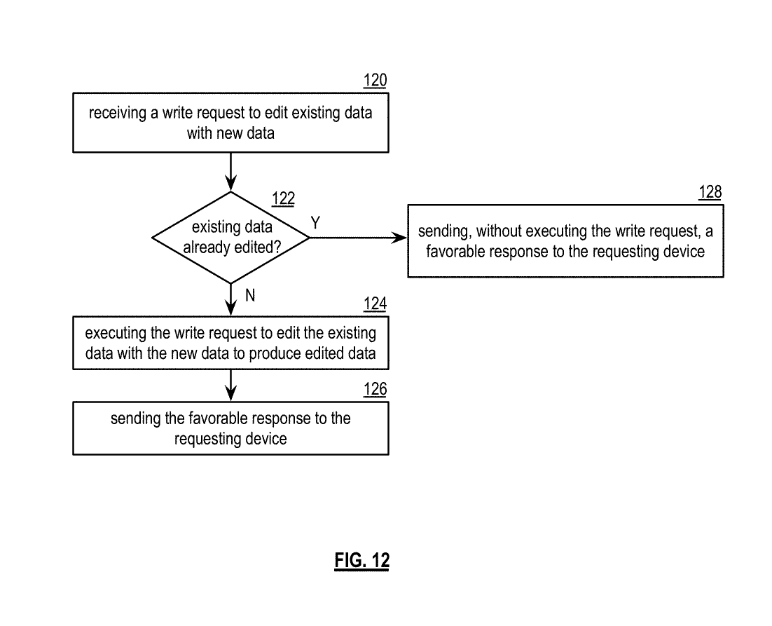

FIG. 12 is a flowchart illustrating an example of a method of editing existing data in a dispersed storage network (DSN). The method begins with step 120, where a computing device (e.g., a dispersed storage processing unit, a DST processing unit, a DST execution unit, a storage unit, etc.) of the DSN receives, from a requesting device of the DSN, a write request to edit existing data with new data. The existing data is stored in the DSN. The write request includes one or more of the new data and information regarding the new data.

Having received the write request, the method continues to step 122, where the computing device determines, based on existing data information and the new data information, whether the existing data has already been edited with the new data. Note the existing data information corresponds to a current state of the existing data, where, when the write request is a first write request regarding the editing of the existing data with the new data, the current state of the existing data is prior to execution of the first write request. Further, when the write request is a second write request in time to the first write request, then the current state of the existing data is subsequent to the execution of the first write request, wherein the second write request includes the new data and is requesting editing of the existing data with the new data.

In one example, the computing device determining whether the existing data has already been edited with the new data includes obtaining (e.g., generating, receiving, etc.) a first subset of the existing data information and a corresponding first subset of the new data information, where the obtaining the first subset of the existing data information and the corresponding first subset of new data information does not require the computing device to read one or more of the new data and the existing data. The determining further includes determining whether the first subset of the existing data information substantially matches the corresponding first subset of the new data information. When the first subset of the existing data information does not substantially match the corresponding first subset of the new data information, the computing device determines the existing data has not already been edited. Note the first subset of the existing data information and the corresponding first subset of new data information includes one or more of a data size, a revision level, a data type, data format, an encryption type, a compression type, a user tag, and a data name (e.g., data object name, source name, slice name).

Continuing with the example, when the first subset of the existing data information does not substantially match the corresponding first subset of the new data information, the computing device determines that the existing data has not been edited. When the first subset of the existing data information substantially matches the corresponding first subset of the new data information, the computing device obtains a second subset of the existing data information and a corresponding second subset of new data information. In an example, the second subset of the existing data information and a corresponding second subset of new data information includes one or more of integrity information, the existing data and the new data. The computing device then determines whether the second subset of the existing data information substantially matches the corresponding second subset of the new data information. When it does not match, the computing device determines the existing data has already been edited.

When it matches, the computing device determines the existing data has already been edited. When the computing device determines the existing data has already been edited, the method continues to step 128, where the computing device sends, without executing the write request, a favorable response to the requesting unit indicating the existing data has been successfully edited. When the computing device determines the existing data has not already been edited, the method continues to step 124 where the computing device executes the write request to edit the existing data with the new data to produce edited data, where the edited data is stored in the DSN. The method continues to step 126, where the computing device sends the favorable response to the requesting device. Note a computer readable storage medium that includes one or more elements that store operational instructions that when executed by a computing device, is operable to perform any of the above methods.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for execution by a computing device of a dispersed storage network (DSN) comprises:
receiving, from a requesting device of the DSN, a write request to edit existing data with new data, wherein the existing data is stored in the DSN, and wherein the write request includes the new data and information regarding the new data;
determining, based on existing data information and the new data information, whether the existing data has already been edited with the new data, wherein the existing data information corresponds to a current state of the existing data, wherein, when the write request is a first write request regarding editing of the existing data with the new data, the current state of the existing data is prior to execution of the first write request and, when the write request is a second write request in time to the first write request, then the current state of the existing data is subsequent to the execution of the first write request, and wherein the second write request includes the new data and is requesting editing of the existing data with the new data;
when the existing data has already been edited:
sending, without executing the write request, a favorable response to the requesting device indicating the existing data has been successfully edited; and
when the existing data has not already been edited:
executing the write request to edit the existing data with the new data to produce edited data, wherein the edited data is stored in the DSN; and
after successful execution of the first write request, sending the favorable response to the requesting device.

2. The method of claim 1, wherein the determining whether the existing data has already been edited with the new data comprises:
obtaining a first subset of the existing data information and a corresponding first subset of the new data information, wherein the obtaining the first subset of the existing data information and the new data information does not require the computing device to read one or more of the new data and the existing data;
determining whether the first subset of the existing data information substantially matches the corresponding first subset of the new data information; and
when the first subset of the existing data information does not substantially match the corresponding first subset of the new data information, determining the existing data has not already been edited.

3. The method of claim 2 further comprises:
when the first subset of the existing data information substantially matches the corresponding first subset of the new data information:
obtaining a second subset of the existing data information and a corresponding second subset of new data information;
determining whether the second subset of the existing data information substantially matches the corresponding second subset of the new data information; and
when the second subset of existing data information does not substantially match the second subset of the new data information, determining the existing data has already been edited.

4. The method of claim 3, wherein the second subset of the existing data information and the corresponding second subset of new data information comprises one or more of:
integrity information;
the existing data; and
the new data.

5. The method of claim 2, wherein the first subset of existing data information and the corresponding first subset of the new data information includes one or more of:
a data size;
a revision level;
a data type;
a user tag; and
a data name.

6. The method of claim 1, wherein the write request includes one or more of:
a user tag of the new data;
a size of the new data;
a data type of the new data;
a revision number of the new data;
a name of the new data;
integrity information of the new data; and
the new data.

7. The method of claim 1, wherein the computing device comprises one of:
a dispersed storage (DS) processing unit; and
a storage unit.

8. The method of claim 7, wherein when the computing device is the DS processing unit, a data name included in one or more of the existing data information and the new data information is a source name.

9. The method of claim 7, wherein when the computing device is the storage unit, a data name included in one or more of the existing data information and the new data information is a slice name.

10. The method of claim 1, wherein data of the existing data and the new data comprises one or more of:
a data object;
a data segment;
a set of encoded data slices; and
an encoded data slice.

11. A computing device of a dispersed storage network (DSN) comprises:
memory;
an interface; and
a processing module operably coupled to the interface and the memory, wherein the processing module is operable to:
receive, via the interface and from a requesting device of the DSN, a write request to edit existing data with new data, wherein the existing data is stored in the DSN, and wherein the write request includes the new data and information regarding the new data;
determine, based on existing data information and the new data information, whether the existing data has already been edited with the new data, wherein the existing data information corresponds to a current state of the existing data, wherein, when the write request is a first write request regarding the editing of the existing data with the new data, the current state of the existing data is prior to execution of the first write request and, when the write request is a second write request in time to the first write request, then the current state of the existing data is subsequent to the execution of the first write request, and wherein the second write request includes the new data and is requesting editing of the existing data with the new data;
when the existing data has already been edited:
send, via the interface and without executing the write request, a favorable response to the requesting unit indicating the existing data has been successfully edited; and
when the existing data has not already been edited:
execute the write request to edit the existing data with the new data to produce edited data, wherein the edited data is stored in the DSN; and
after successful execution of the first write request, send, via the interface, the favorable response to the requesting device.

12. The computing device of claim 11, wherein the processing module is operable to determine whether the existing data has already been edited with the new data by:
obtaining a first subset of the existing data information and a corresponding subset of the new data information, wherein the obtaining the first subset of the existing data information and the new data information does not require the computing device to read one or more of the new data and the existing data;
determining whether the first subset of the existing data information substantially matches the corresponding first subset of the new data information; and
when the first subset of the existing data information does not substantially match the corresponding first subset of the new data information, determining the existing data has not already been edited.

13. The computing device of claim 12, wherein the processing module is further operable to:
when the first subset of the existing data information substantially matches the corresponding first subset of the new data information:
obtain a second subset of the existing data information and a corresponding second subset of new data information;
determine whether the second subset of the existing data information substantially matches the corresponding second subset of the new data information; and
when the second subset of existing data information does not substantially match the second subset of the new data information, determine the existing data has already been edited.

14. The computing device of claim 13, wherein the second subset of the existing data information and the corresponding second subset of new data information comprises one or more of:
integrity information;
the existing data; and
the new data.

15. The computing device of claim 12, wherein the first subset of existing data information and the corresponding first subset of the new data information includes one or more of:
a data size;
a revision level;
a data type;
a user tag; and
a data name.

16. The computing device of claim 11, wherein the write request includes one or more of:
a user tag of the new data;
a size of the new data;
a data type of the new data;
a revision number of the new data;
a name of the new data;
integrity information of the new data; and
the new data.

17. The computing device of claim 11, wherein the computing device comprises one of:
a dispersed storage (DS) processing unit; and
a storage unit.

18. The computing device of claim 17, wherein when the computing device is the DS processing unit, a data name included in one or more of the existing data information and the new data information is a source name.

19. The computing device of claim 17, wherein when the computing device is the storage unit, a data name included in one or more of the existing data information and the new data information is a slice name.

20. The computing device of claim 11, wherein data of the existing data and the new data comprises one or more of:
a data object;
a data segment;
a set of encoded data slices; and
an encoded data slice.
